(19) United States
(12) Patent Application Publication
(10) Pub. No.: US 2007/0277779 A1
(43) Pub. Date: Dec. 6, 2007

(54) System for exhaust valve actuation

(75) Inventors: Thomas R. McClure, Washington, IL (US); Sean O. Cornell, Gridley, IL (US); John S. Pipis, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: CATERPILLAR INC.

(21) Appl. No.: 11/443,057

(22) Filed: May 31, 2006

(51) Int. Cl. F02D 13/04; F01L 1/34

(52) U.S. Cl. 123/322; 123/321; 123/90.16

(57) ABSTRACT

A variable valve actuation system is disclosed for providing exhaust to at least one component downstream of an engine. The system includes an exhaust valve disposed in an engine cylinder and a hydraulic actuation system. The system also includes a braking control valve, a supply of hydraulic fluid operably connected to the hydraulic actuation system, and an exhaust valve actuating device operably connected to the valve actuation system. The exhaust valve actuating device is operable to affect the exhaust valve to open within the engine cylinder. The system further includes a device for controlling a position of the exhaust valve actuating device relative to a position of the exhaust valve. The controlling device is operably connected to the supply of hydraulic fluid.

### TECHNICAL FIELD

This present disclosure relates generally to a system for valve actuation and, more particularly, to a method and apparatus for exhaust valve actuation.

### BACKGROUND

Allowable limits of particulates and noxious gases produced by internal combustion engines, including those produced by diesel engines, are generally regulated by government agencies. Manufacturers of such engines have accordingly devised techniques for controlling exhaust emissions. Many engines typically include an exhaust system particulate filter or trap, e.g., a soot filter. Particulate filters are generally designed to collect particulate emissions within the exhaust stream and either continuously or periodically burn off the collected particulates in a particulate filter regeneration mode. During a particulate filter regeneration mode, the temperature within the filter is preferably above a specified regeneration temperature to ensure thorough burning of the collected particulates.

Particulate filters include active and passive types. Active particulate filters typically include one or more heaters for filter regeneration, and passive particulate filters typically rely on the temperature of the exhaust gas itself to sufficiently elevate the filter temperature for filter regeneration. Particulate filters are usually designed such that normal operation of the engine produces exhaust temperatures at or above a desired temperature to enable filter regeneration. However, under certain engine operating conditions, such as extended periods of engine idling and sustained operation at high engine speeds or low output torque, exhaust gas temperatures produced may be below the filter regeneration temperature and may adversely affect filter regeneration. As a result, particulate filters may frequently become clogged or plugged, thereby requiring unscheduled vehicle maintenance in order to clean the clogged or plugged filter. Additionally, particulate filter clogging or plugging may also result in filter failure through generation of excessive temperatures internal to the filter when soot is burned.

As shown in U.S. Pat. No. 6,427,436 (the '436 patent), a filter system can be used to remove particulate matter from a flow of engine exhaust gas before a portion of the gas is fed back to an intake air stream of the engine. Specifically, the '436 patent discloses an engine exhaust filter containing a catalyst and a filter element. A portion of the filtered exhaust is extracted downstream of the filter and is directed to an intake of the engine through a recirculation loop.

Although the filter system of the '436 patent may protect the engine from an amount of harmful particulate matter, the catalyst may convert sulfur present in the exhaust gas to sulfate. The sulfate may combine with condensed water to form sulfuric acid in the recirculation loop. The recirculation of sulfuric acid may corrode components of the system over time and may hinder the effectiveness and longevity of the system. In addition, the system of the '436 patent may not be capable of regenerating the filter element to remove particulate matter and other exhaust components trapped therein.

The disclosed system is directed to overcoming one or more of the shortcomings set forth above.

### SUMMARY OF THE INVENTION

In one aspect, the present disclosure is directed to a variable valve actuation system for providing exhaust to at least one component downstream of an engine. The system includes an exhaust valve disposed in an engine cylinder and a hydraulic actuation system. The system also includes a braking control valve, a supply of hydraulic fluid operably connected to the hydraulic actuation system, and an exhaust valve actuating device operably connected to the valve actuation system. The exhaust valve actuating device is operable to affect the exhaust valve to open within the engine cylinder. The system further includes a device for controlling a position of the exhaust valve actuating device relative to a position of the exhaust valve. The controlling device is operably connected to the supply of hydraulic fluid.

In another aspect, the present disclosure is directed to a method of providing exhaust downstream of an engine system. The engine system includes a braking control valve operably connected to a hydraulic actuation system, an exhaust valve actuating device connected to the hydraulic actuation system, an exhaust valve disposed in an engine cylinder, and a device for controlling a position of the exhaust valve actuating device between a first position and a second position. The method includes positioning the exhaust valve actuating device at the first position relative to the exhaust valve or at the second position relative to the exhaust valve via the controlling device. The method further includes enabling the exhaust valve actuating device to engage the exhaust valve from the first position or the second position.

In yet another aspect, the present disclosure is directed to a variable valve actuation system for providing exhaust utilized in a regeneration process. The system includes an exhaust valve disposed in an engine cylinder and a braking control valve operably connected to the valve actuation system. The system also includes a hydraulic actuation system including a first piston assembly having a housing, a piston slidable in said housing, a plunger pin coupled to the piston, and a spring arranged to urge the piston in a first direction. The plunger pin is operable to engage the exhaust valve to open within the engine cylinder. The system further includes a device for controlling a position of the plunger pin relative to a position of the exhaust valve.

### BRIEF DESCRIPTION OF THE DRAWINGS

FIG. 1 is a diagrammatic illustration of an engine having an exhaust treatment system according to an exemplary embodiment of the present disclosure;

FIG. 2 is a schematic illustration of a variable valve actuation system utilized to control a supply of high temperature exhaust toward the exhaust treatment system of FIG. 1; and

FIG. 3 is another schematic illustration of the variable valve actuation system of FIG. 2.

### DETAILED DESCRIPTION

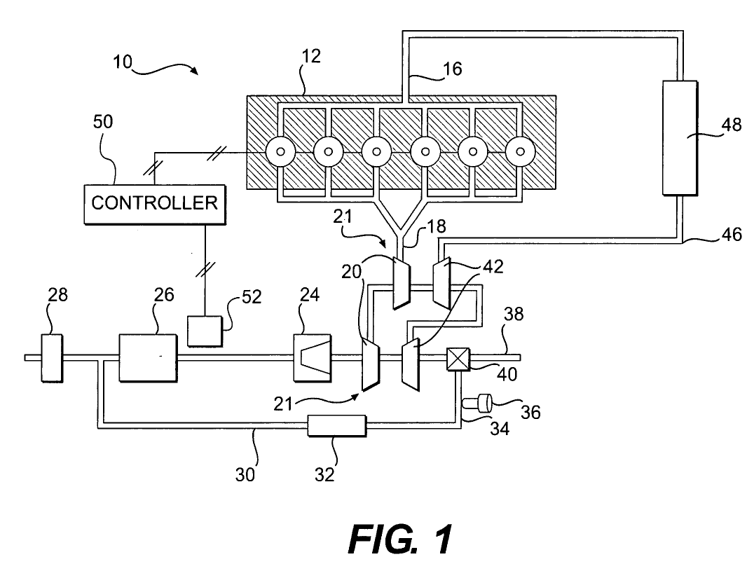

FIG. 1 illustrates an exemplary exhaust treatment system 10 operatively connected with an internal combustion engine 12. Internal combustion engine 12 may include, for example, a diesel engine, a gasoline engine, a gaseous fluid driven engine, or any other engine known in the art. Internal combustion engine 12 may include one or more piston-cylinder arrangements each of which may operate on a four-stroke cycle, including an intake stroke, a compression stroke, a power stroke, and an exhaust stroke. The movement and positioning of a piston with respect to a cylinder throughout the four-stroke cycle is known in the art and, as such, is not further described. Internal combustion engine 12 may also include one or more intake and/or exhaust valves associated with respective piston-cylinder arrangements. The intake valves may be configured to supply air or a mixture of fuel and air toward a respective cylinder and the exhaust valves may be configured to deliver combustion byproducts, e.g., exhaust gas, toward exhaust treatment system 10.

Exhaust treatment system 10 may be configured to extract energy from the exhaust gas, filter the exhaust gas, and selectively supply filtered exhaust gas back to an intake system of the engine 12. Specifically, the exhaust gas may flow through flow lines 18 to a plurality of turbines 20 associated with a series of turbochargers 21. During this process, energy is extracted from the exhaust gas to drive compressors 42 coupled to turbines 20 of turbochargers 21. It is contemplated that exhaust treatment system 10 may, alternatively, include a single turbocharger or may not include any turbochargers.

After flowing through turbines 20, the exhaust gas may travel through a regeneration device 24 that is configured to increase the temperature of the exhaust gas before a filter 26. Regeneration device 24 may include, for example, a fuel injector and an igniter, heat coils, and/or other heat sources known in the art. Such heat sources may be disposed within regeneration device 24 and may be configured to increase the temperature of the exhaust gas via convection, combustion, and/or other heat transfer methods. It is contemplated that if regeneration device 24 includes a fuel injector and an igniter, regeneration device 24 may receive a supply of fuel and oxygen to facilitate combustion therein. It is also contemplated that regeneration device 24 may, alternatively, be omitted.

Filter 26 may be connected downstream of regeneration device 24 and may receive heated exhaust gas therefrom. Filter 26 may include any type of filter known in the art capable of extracting matter, e.g., soot, from a flow of gas. For example, filter 26 may include a particulate matter filter positioned to extract particulates from exhaust gas, e.g., a ceramic substrate, a metallic mesh, foam, or any other porous material known in the art. It is contemplated that these materials may form, for example, a honeycomb structure within a housing of filter 26 to facilitate the removal of particulates.

After the exhaust gas has traveled through filter 26, it may flow through a catalyst 28 disposed downstream of the filter 26 and/or may flow toward internal combustion engine 12 via a recirculation line 30 and a cooler 32. The amount of exhaust gas recirculated toward internal combustion engine 12 may be controlled by a mixing valve 40 and flow sensor 36 via flow line 34. As is know in the art, recirculated exhaust gas may be mixed with ambient intake air 38, compressed by compressors 42, cooled by an aftercooler 48, and directed toward an intake manifold 16 of the engine 12.

As noted above, filter 26 may periodically require regeneration to assist in cleaning filter 26. The process of regeneration requires heating filter 26 to elevated temperatures in order to burn some of the particulates that have collected within filter 26. The temperature of the exhaust gas that have traveled through turbines 20 of the turbochargers may not be sufficient to produced regeneration within filter 26. Accordingly, regeneration device 24 may increase the temperature of the exhaust gases directed toward filter 26 to establish the temperature of the exhaust gas above a desired temperature for regeneration. It is contemplated that if regeneration device 24 is selectively omitted, filter 26 may include one or more heat sources and/or catalysts which may aid a regeneration process either by increasing the temperature of exhaust gases and/or by enabling regeneration at lower exhaust gas temperatures.

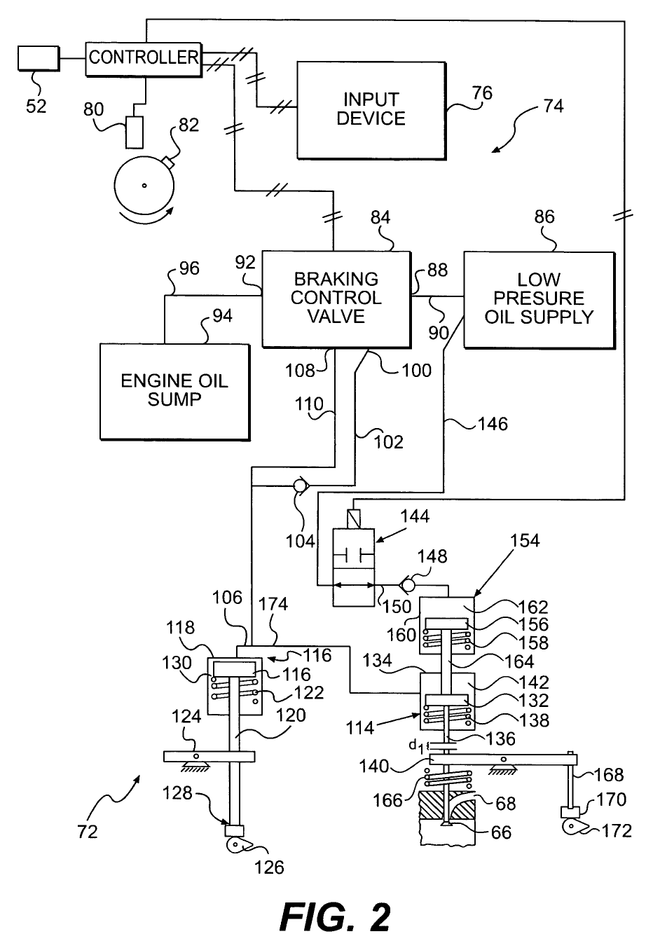

A controller 50 may be configured to control one or more operations of internal combustion engine 12. Specifically, controller 50 may affect the operation of one or more of the exhaust valves associated with the one or more piston-cylinder arrangements to increase the temperature of exhaust gas delivered from internal combustion engine 12 toward exhaust treatment system 10. Controller 50 may embody an electronic control module and may include one or more microprocessors, a memory, a data storage device, a communications hub, and/or other components known in the art. It is contemplated that controller 50 may be integrated within a general control system capable of controlling additional functions of internal combustion engine 12, e.g., a fuel delivery system. Controller 50 may be configured to receive input signals from a sensor 52 and/or additional input devices, e.g., an operator interface device (not shown), perform one or more algorithms to determine appropriate output signals, and may deliver the output signals to one or more devices to affect the temperature of the exhaust gas produced by internal combustion engine 12. It is contemplated that controller 50 may receive and deliver signals via one or more communication lines (not referenced) as is known in the art. Sensor 52 may include any conventional sensor configured to establish a signal indicative of a temperature of a fluid. Specifically, sensor 52 may be disposed downstream of turbines 20 of the turbochargers 21 and upstream of the filter 26. The process of increasing the temperature of the exhaust gas delivered from internal combustion engine 12 toward exhaust treatment system will be described in connection with FIG. 2 below.

FIG. 2 illustrates a variable valve actuation system 72 configured to control the movement of an exhaust valve 66 of the internal combustion engine 12. Specifically, controller 50 may, in response to a need for providing increased temperature exhaust for a regeneration process, adjust the movement of exhaust valve 66. Variable valve actuation system 72 may include an engine braking system 74 configured to adjust the movement of exhaust valve 66 to reduce the power output of internal combustion engine 12, a control valve 144, and a positioning device 154.

Engine braking system 74 may include, for example, an engine compression braking system for a multi-cylinder engine including an input device 76 electrically coupled to controller 50. Input device 76 may be, for example, a selectively switchable control available in an operator compartment of a vehicle, an automatic switch associated with a vehicle brake pedal, or any other known method of providing an input signal. Optionally, engine braking system 74 may include a sensor 80 configured to sense a crankshaft position indicator 82. Indicator 82 may be correlated to a top-dead-center position of a piston of a piston-cylinder arrangement.

Engine braking system 74 further includes a low pressure supply 86 of hydraulic fluid, such as oil, at low pressure. The low pressure supply 86 may be the lubrication oil passed through the engine gallery to lubricate bearings and other engine components. The braking control valve 84 may include a supply port 88 fluidly coupled to the low pressure supply 86 via a hydraulic line 90. A braking control valve 84 may also include a vent port 92 fluidly coupled to an engine fluid sump 94 via a hydraulic line 96. Controller 50 may be electrically coupled to one or more braking control valves 84. Although only one braking control valve 84 is illustrated, it is contemplated that more than one braking control valve 84 may be required for an engine having multiple piston-cylinder arrangements.

The engine braking system 74 may also include a hydraulic actuation system 98, associated with exhaust valve 66. Braking control valve 84 may include an actuation port 100 fluidly coupled to hydraulic actuation system 98 via a hydraulic manifold 102 which may include a check valve 104 arranged therein to prevent fluid from flowing through hydraulic manifold 102 toward braking control valve 84. Braking control valve 84 may also include a drain port 108 fluidly coupled to hydraulic actuation system 98 via hydraulic line 110.

Hydraulic actuation system 98 may include a first piston assembly 112 and a second piston assembly 114. First piston assembly 112 may include a piston 116 slidable in a housing 118 and coupled with a plunger pin 120. A spring 122 may be disposed within housing 118 and configured to urge the piston 116 in a first direction. Plunger pin 120 may be mechanically coupled to a rocker arm 124 associated with, for example, a fuel injection system (not shown). Rocker arm 124 may be mechanically coupled to a rotatable cam 126, e.g., a cam having a cam profile that determines fuel injection timing, and an associated cam follower 128 so as to transfer rotational motion of the cam 126 into linear motion of the piston 116 in the first direction. Additionally, piston 116 and housing 118 may be configured as a first pressure chamber 130 in fluid communication with an actuator manifold 106. It is contemplated that rocker arm 124 may, alternatively, be independent of the fuel injection system.

Second piston assembly 114 may include a piston 132 slidable in a housing 134 and coupled with a plunger pin 136. A spring 138 may be disposed within housing 134 and configured to urge piston 132 in a first direction. A plunger pin 136 may be mechanically coupled to a rocker arm 140 and associated with exhaust valve 66. Piston 132 and housing 134 may be configured to define a second pressure chamber 142 in fluid communication with actuator manifold 106. It is contemplated that rocker arm 140 may be mechanically coupled to a rotatable camshaft, cam 172, associated cam follower 170, and push rod 168 to transfer rotational motion of the camshaft to linear motion of exhaust valve 66 to affect movement, e.g., opening and closing, thereof. Additionally, a spring 166 may be configured to urge exhaust valve 66 toward a closed position.

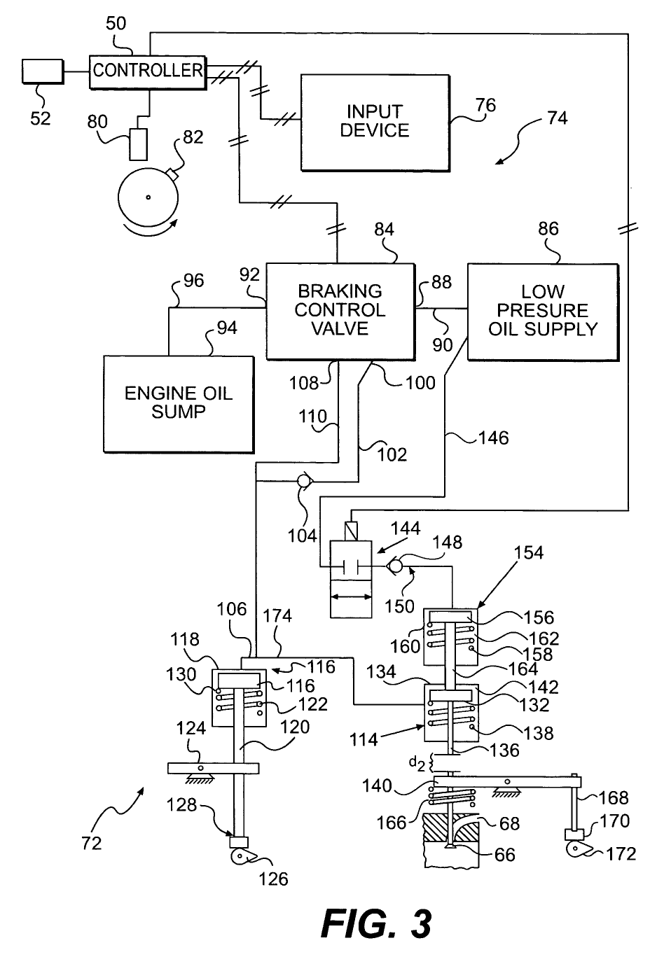

Control valve 144 may be configured to control a flow of pressurized fluid from low pressure supply 86 via a hydraulic line 146 toward positioning device 154 via a check valve 148. Specifically, control valve 144 may include a two-position solenoid actuated valve. Controller 50 may be configured to affect movement of control valve 144, via a suitable control signal, between a first position in which pressurized fluid may be allowed to flow from low pressure supply 86 toward check valve 148 and a second position in which pressurized fluid may be blocked from flowing from low pressure supply 86 toward check valve 148. It is contemplated that in an engine braking mode control valve 144 may be in the first position, to allow hydraulic fluid therethrough and toward check valve 148, see FIG. 2, and that in a regeneration mode control valve 144 may be in the second position, such that no fluid would be allowed to flow toward check valve 148, see FIG. 3. It is also contemplated that control valve 144 may include any suitable valve configured to control a flow of pressurized fluid from low pressure supply 86 toward check valve 148, such as, for example, a mechanically or hydraulically actuated multi-position valve.

Positioning device 154 may be hydraulically activated as a function of the position of control valve 144. Specifically, positioning device 154 may include a third piston assembly and may be connected to control valve 144 via a hydraulic line 150. For example, the third piston assembly may include a piston 156 slidable in a housing 160 and coupled with a plunger pin 164. A spring 158 may be arranged to urge piston 156 in a first direction. The position of plunger pin 136 may be adjusted in proportion to amount of displacement of piston 156 and as a function of the amount of fluid within the third piston assembly. Piston 156 and housing 160 may define a third pressure chamber 162 in fluid communication with hydraulic line 146. It contemplated that positioning device 154 may embody any suitable type of accumulator configured to accumulate an amount of pressurized fluid.

The position of plunger pin 164 may affect a position of piston 132 of second piston assembly 114 and thus the clearance between plunger pin 136 and rocker arm 140. Specifically, plunger pin 164 of the third piston assembly may be abutted against piston 132 of second piston assembly 114 and configured to move piston 132 and thus plunger pin 136 in a direction towards rocker arm 140. Spring 158 may urge piston 156 and thus plunger pin 164 away from piston 132 and spring 138 may urge piston 132 and thus plunger pin 136 in a direction away from rocker arm 140. A first clearance space d1, or first lash, may be defined between a bottom of plunger pin 136 and rocker arm 140 when plunger pin 164 of positioning device 154 may be in a first position as shown, for example, in FIG. 2. A second clearance space d2, or second lash, may be defined between a bottom of plunger pin 136 and rocker arm 140 when plunger pin 164 of positioning device 154 may be in a second position as shown, for example, in FIG. 3. As such, the lash between the bottom of plunger pin 136 and rocker arm 140 may be adjusted between a variety of positions as a function of the amount of pressurized fluid supplied toward positioning device 154. It is contemplated that the first lash d1 may be desired for an engine braking mode and the second lash d2 may be desired for controlling exhaust temperature.

### INDUSTRIAL APPLICABILITY

The disclosed system for exhaust valve actuation for regeneration may be applicable for any combustion engine to increase the temperature of exhaust gas delivered toward downstream components, e.g., regenerators, filters, catalytic converters, and/or any other components known in the art. The disclosed system may adjust the timing of one or more exhaust valves associated with an internal combustion engine to increase the temperature of the exhaust gas directed toward a regenerator and/or a filter. The operation of variable valve actuation system 72 will be explained below.

Controller 50 may enter an engine braking mode in response to a signal from input device 76. During an engine braking mode, fuel supply to internal combustion engine 12 may be stopped. Controller 50 may receive signals from sensor 80 to establish appropriate timing during the engine braking mode such that compressed air is released from one or more cylinders of internal combustion engine 12 by opening an exhaust valve associated therewith when a piston is near a top-dead-center position of a compression stroke. It is contemplated that compressed air may be released from any number of cylinders to facilitate the desired braking affect during a particular engine braking mode.

In the engine braking mode, controller 50 may deliver signals to braking control valve 84 to allow fluid communication between supply port 88 and actuation port 100 and may block fluid communication between drain port 108 and sump 94. As a result, hydraulic fluid from low pressure supply 86 may flow toward hydraulic manifold 102 and may be available for use by hydraulic actuation system 98. If the pressure of fluid in hydraulic manifold 102 overcomes check valve 104, the pressurized fluid may flow toward the actuator manifold 106, return line 110, and toward first and second pressure chambers 130, 142. Check valve 104 may be configured to maintain the pressurized fluid available to the hydraulic actuation system 98 at a predetermined pressure by allowing pressurized fluid to flow from hydraulic manifold 102 when the pressure of fluid in the associated actuator manifold 106 and return line 110 drops below a predetermined pressure. During an engine braking mode, controller 50 may deliver a signal configured to actuate control valve 144 toward the first position to allow a flow of pressurized fluid from low pressure supply 86 toward positioning device 154 via check valve 148. If the pressure of fluid in hydraulic line 146 overcomes check valve 148, the pressurized fluid may flow toward positioning device 154. As such, piston 156 and plunger pin 164 may displace piston 132 to establish first lash d1. It is contemplated that pressurized fluid may be discharged from positioning device 154 to an environment, e.g., the atmosphere, by the force of spring 158 urging piston 156 away from rocker arm 140. However, as the pressure decreases within positioning device 154, pressurized fluid within hydraulic line 146 may flow through control valve 144 controlled to be in the first position, overcome check valve 148, and may flow toward positioning device 154 replenishing the discharged fluid. As such, a position of the plunger pin 164 may become hydraulically locked as it is retained in place by pressurized hydraulic fluid contained within the third pressure chamber 162 of the positioning device 154.

When braking control valve 84 is enabled, piston assembly 112, e.g., a “master” piston assembly, may act as a pump, providing pressurized fluid to piston assembly 114, e.g., a “slave” piston assembly. For example, linear movement of piston 116 of first piston assembly 112 in a direction of the force of spring 122, in response to motion of cam 126, cam follower 128, and rocker arm 124, may cause linear movement of piston 132 of second piston assembly 114. Specifically, the pressurized fluid within first pressure chamber 130, actuator manifold 106, return line 110, and second pressure chamber 142 may not be relieved and piston 132 of second piston assembly 114 may be moved in a direction opposite to the force of spring 138. Plunger pin 136 may be urged downward against rocker arm 140, which may urge exhaust valve 66 to an open position. The open position of the exhaust valve 66 allows compressed air to escape the cylinder via exhaust outlet 68 thereby performing an engine braking function as is known in the art. As such, rotation of the cam 126 causes the exhaust valve 66 to open and close in a cyclical manner during the engine braking mode. It is noted that plunger pin 136, in engine breaking mode, overcomes first lash d1 because control valve 144 allows pressurized fluid to flow toward positioning device 154 and plunger pin 164 displaces piston 132 and plunger pin 136. It is contemplated that in certain embodiments exhaust valve 66 may be opened approximately 15 degrees before top dead center of a compression stroke when plunger pin 136 overcomes first lash d1.

Spring 138 of second piston assembly 114 may urge piston 132 to a return position. A return movement of the piston 132 may be limited to a position at which piston 132 abuts a fixed position of plunger pin 164. It is contemplated that by varying the lash between plunger pin 136 and rocker arm 140, a timing adjustment may be employed when urging the exhaust valve 66 to open.

When controller 50 is not operated in the engine braking mode, braking control valve 84 may not be actuated and pressurized fluid may be blocked from flowing toward actuation port 100 and drain port 108 may be in fluid communication with engine fluid sump 94 via vent port 92.

The temperature of the exhaust gas directed toward regeneration device 24 and/or toward filter 26, may be increased by regulating the movement of exhaust valve 66 via variable valve actuation system 72. Specifically, sensor 52 may deliver a signal to controller 50 indicative of a temperature below a predetermined value and controller 50 may determine that it is desirable to increase the temperature of the exhaust gas. Additionally, controller 50 may receive a signal from sensor 80 to establish a timing associated with the crankshaft and thus the pistons of internal combustion engine 12. For example, controller 50 may determine the appropriate timing such that relatively high temperature combustion air and/or exhaust gas may be released from the piston-cylinder arrangement associated with exhaust valve 66. That is, controller 50 may be configured to open exhaust valve 66 during a power stroke of a piston.

In the regeneration mode, controller 50 may deliver a signal to actuate control valve 144 toward the second position to substantially block pressurized fluid from flowing therethrough and toward positioning device 154. As such, control valve 144 may selectively prohibit pressurized fluid from flowing toward positioning device 154 and thus may prohibit pressurized fluid from replenishing the fluid discharged from positioning device 154 toward an environment. Accordingly, as shown, for example, in FIG. 3, spring 158 may urge piston 156 and plunger pin 164 away from rocker arm 140 and spring 138 may urge piston 132 away from rocker arm 140 to establish second lash d2 between the bottom of the plunger pin 136 and the rocker arm 140. It is contemplated that piston 132 may abut plunger pin 164 to establish second lash d2 and that second lash d2 may be, for example, greater than first lash d1.

Controller 50 may also deliver a signal to actuate braking control valve 84 to allow a flow of pressurized fluid from supply port 88 toward actuation port 100 and to block a flow of pressurized fluid from drain port 108 toward engine sump 94. As a result, pressurized fluid from low pressure supply 86 may flow toward hydraulic manifold 102 and may be available for use by hydraulic actuation system 98.

If the pressure of hydraulic fluid in a hydraulic manifold 102 is high enough to open the associated check valve 104, then the fluid may flow to the associated actuator manifold 106 and hydraulic lines 110, 146, and 174, as well as to the first pressure chamber 130 and the second pressure chamber 142. The check valve 104 may be structured and arranged to allow fluid flow from the hydraulic manifold 102 when the pressure of fluid in the associated actuator manifold 106 and return line 110 drops below a predetermined pressure.

Similar to the engine braking mode, “master” piston assembly 112 may act as a pump, providing pressurized fluid to “slave” piston assembly 114. Plunger pin 136 may be urged downward against the rocker arm 140, which may urge exhaust valve 66 to an open position. Because piston 156 and plunger pin 164 are not displaced, piston 132 and plunger pin 136 overcome second lash d2 before urging exhaust valve 66 to an open position. As such, the timing of exhaust valve 66 in regeneration mode may be different than the timing of exhaust valve 66 in braking mode. It is contemplated that for certain embodiments exhaust valve 66 may be opened approximately 20-30 degrees after top dead center of a power stroke when plunger pin 136 overcomes second lash d2.

It is contemplated that the opening and timing of exhaust valve 66 of hydraulic actuation system 98 may be predetermined to produce a desired amount of high temperature exhaust downstream of internal combustion engine 12. For example, any number of the exhaust valves associated with the one or more piston-cylinder arrangements of internal combustion engine 12 may be opened during a power stroke.

Because controller 50 may allow pressurized fluid to flow toward the hydraulic actuation system 98 by controlling braking control valve 84 when a braking mode is not desired and may adjust the lash between plunger pin 136 and rocker arm 140, by controlling control valve 144, different exhaust valve opening timings may be established. Additionally, by establishing second lash d2 greater than first lash d1, exhaust valve 66 may be opened later with respect to a piston stroke during a four cycle combustion process in a regeneration mode than in an engine braking mode. As such, high temperature exhaust gas may be delivered downstream of internal combustion engine 12.

It will be apparent to those skilled in the art that various modifications and variations can be made to the disclosed system for exhaust valve actuation for regeneration. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A variable valve actuation system for providing exhaust to at least one component downstream of an engine, comprising:
an exhaust valve disposed in an engine cylinder;
a hydraulic actuation system;
a braking control valve and a supply of hydraulic fluid operably connected to the hydraulic actuation system;
an exhaust valve actuating device operably connected to the hydraulic actuation system, the exhaust valve actuating device operable to affect the exhaust valve to open within the engine cylinder; and
a device for controlling a position of the exhaust valve actuating device relative to a position of the exhaust valve, the controlling device operably connected to the supply of hydraulic fluid.

2. The system according to claim 1, further comprising:
an engine fluid sump wherein the braking control valve is configured to be coupled to the supply of hydraulic fluid and the engine fluid sump.

3. The system according to claim 1, further comprising:
a first piston assembly wherein the exhaust valve actuating device is operably connected to the first piston assembly and the hydraulic actuation system.

4. The system according to claim 3, wherein the exhaust valve actuating device comprises a second piston assembly.

5. The system according to claim 1, further comprising a device for selectively coupling the controlling device with the supply of hydraulic fluid.

6. The system according to claim 5, wherein the device for selectively coupling comprises a two-way solenoid control valve.

7. The system according to claim 5, further comprising:
an electronic control module configured to enable and disable the fluid coupling device and the braking control valve.

8. The system according to claim 7, wherein:
the exhaust valve actuating device is positioned at a first position relative to the exhaust valve when the device for selectively coupling allows a flow of hydraulic fluid toward the controlling device; and
the exhaust valve actuating device is positioned at a second position relative to the exhaust valve when the device for selectively coupling blocks a flow of hydraulic fluid toward the controlling device.

9. The system according to claim 7, wherein:
a first distance is defined between the exhaust valve actuating device and the exhaust valve when the device for selectively coupling allows hydraulic fluid to flow toward the controlling device and the piston is displaced; and
a second distance is defined between the exhaust valve actuating device and the exhaust valve when the device for selectively coupling blocks hydraulic fluid from flowing toward the controlling device and the piston is not displaced.

10. The system according to claim 9, wherein the second distance is greater than the first distance.

11. A method of providing exhaust downstream of an engine system having a braking control valve operably connected to a hydraulic actuation system, an exhaust valve actuating device connected to the hydraulic actuation system, an exhaust valve disposed in an engine cylinder, and a device for controlling a position of the exhaust valve actuating device between a first position and a second position, the method comprising:
positioning the exhaust valve actuating device at the first position relative to the exhaust valve or at the second position relative to the exhaust valve via the controlling device; and
enabling the exhaust valve actuating device to engage the exhaust valve from the first position or the second position.

12. The method according to claim 11, wherein the engine system further includes a first piston assembly operably connected to the hydraulic actuation system, the method further comprising:
enabling the exhaust valve actuating device to engage the exhaust valve via the first piston assembly.

13. The method according to claim 12, wherein the exhaust valve actuating device comprises a second piston assembly.

14. A variable valve actuation system for providing exhaust utilized in a regeneration process, comprising:
an exhaust valve disposed in an engine cylinder;
a braking control valve;
a hydraulic actuation system including a first piston assembly having a housing, a piston slidable in said housing, a plunger pin coupled to the piston, and a spring arranged to urge the piston in a first direction, the plunger pin operable to engage the exhaust valve to open within the engine cylinder; and
a device for controlling a position of the plunger pin relative to a position of the exhaust valve.

15. The system according to claim 14, wherein the hydraulic actuation system further includes a second piston assembly operably connected to the first piston assembly, wherein the second piston assembly is configured to enable the first piston assembly to engage the exhaust valve.

16. The system according to claim 14, wherein the controlling device is fluidly coupled to a supply of hydraulic fluid.

17. The system according to claim 16, further comprising a device for selectively coupling the controlling device to the supply of hydraulic fluid.

18. The system according to claim 17, further comprising an electronic control module configured to enable and disable the fluid coupling device and the braking control valve.

19. The system according to claim 18, wherein:
the plunger pin is positioned at a first position relative to the exhaust valve when the device for selectively coupling allows a flow of hydraulic fluid toward the controlling device; and
the plunger pin is positioned at a second position relative to the exhaust valve when the coupling device blocks a flow of hydraulic fluid toward the controlling device.

20. The system according to claim 19, wherein the second distance is greater than the first distance.
